(19) United States
(12) Patent Application Publication
(10) Pub. No.: US 2022/0348249 A1
(43) Pub. Date: Nov. 3, 2022

(54) STROLLER WITH SEAT UNIT

(71) Applicant: Mariam VOLLMAR, Seybothenreuth (DE)

(72) Inventor: Mariam VOLLMAR, Seybothenreuth (DE)

(21) Appl. No.: 17/622,191

(22) PCT Filed: Jul. 6, 2020
(86) PCT No.: PCT/EP2020/068986

§ 371 Date: Dec. 22, 2021

(30) Foreign Application Priority Data
Jul. 5, 2019 (DE) 20 2019 103 701.6

(51) Int. Cl. B62B 9/10; B62B 9/22

(52) U.S. Cl. CPC B62B 9/102; B62B 9/22

(57) ABSTRACT

A stroller has a frame with at least two wheels and a seat unit for supporting a person sitting on it. The seat unit has a seat surface which is designed to be driven movable and/or wherein the seat surface has a plurality of driven movable partial surfaces. A movement pattern of the seat surface and/or the partial surfaces is predetermined in such a way that the back movement of a riding animal is simulated in at least one gait. The seat unit has a kinematic unit for predetermining the movement of the seat surface or the partial surfaces, which is arranged directly below the seat surface or directly below the partial surfaces. Alternatively or additionally, the stroller has a differential connected to at least two wheels so that a combined kinetic energy of these wheels is provided for the movement of the seat surface or the partial surfaces.

The present invention relates to a seating technology which promotes healthy and dynamic sitting and can be used in various seating devices. In particular, the seating technology comprises a stroller with a seat unit having the features in the preamble of the main claim. It further comprises a number of further seating devices provided with at least one seat unit.

It is known that sitting still for long periods of time, especially on a rigid seat surface, leads to an impairment of well-being. If the same immobile sitting posture is maintained repeatedly and over a long period of time, this can lead to postural damage. Various attempts have already been made to promote dynamic sitting.

Thus, on the one hand, it is known from the field of office and desk chairs to provide movable one-piece seating surfaces which deflect under the weight of the person sitting on them, so that the person is stimulated to perform a countermovement with the own muscles.

On the other hand, it is known to provide office chairs with a cross-shaped seat surface so that the person sitting on it can assume different sitting positions, for example with the backrest behind the back, with the backrest in front of the stomach or with the backrest to the side of the upper body.

The seating techniques previously known are not optimally designed. It is the object of the present invention to disclose a stroller with an improved seating technique. The invention solves this object by the characteristic features of the independent claims.

The disclosed stroller further forms the use of riding dynamic seating and provides improved application characteristics. It comprises a seat unit with a kinematic unit (as a self-contained assembly) which predetermines a riding dynamic movement of the seat surface and/or of partial surfaces of the seat surface, wherein said kinematic unit being arranged under the seat surface and in particular directly under the seat surface or directly under the movable partial surfaces. In this way, a compact construction is achieved. Below the kinematic unit, a free space can be created in order to accommodate, for example, equipment such as a luggage net, etc. in an area between the wheels. Furthermore, a significantly simplified assembly of the stroller frame is made possible.

The disclosed stroller further preferably includes a mechanical power unit and a differential. The differential is connected to at least two wheels of the stroller, and in such a way that a combined kinetic energy of these wheels is provided for the movement of the seat surface or the partial surfaces. By this means, a cycle-appropriate movement of the seat surface and/or the moving partial surfaces can be achieved even during cornering of the stroller. Thus, there is no phase shift in the movement of the seat surface or the partial surfaces as a result of cornering. Any feedback effect from the movement of the seat surface on the wheels, which may be perceived as sliding resistance, is distributed proportionally to the at least two wheels connected to the differential.

By providing one or both of the aforementioned features, a stroller is further achieved which, with a correspondingly foldable frame, can be folded particularly compactly in order to accommodate it, for example, in the luggage compartment of a passenger car. And finally, the compact design of the kinematic unit and the transmission of the kinetic energy of the wheels, combined by means of a differential, achieve a weight reduction of the stroller.

The disclosed seating technology includes various aspects, each of which may be used alone or in any combination. In particular, disclosed are a seat unit and various seat devices equipped with the seat unit.

It has been found to be particularly advantageous to provide a seat surface with four movable partial surfaces, wherein these partial surfaces being located under the left and right buttocks and under the left and right lower leg in the intended sitting position. The present disclosure accordingly assumes this arrangement with four partial surfaces in the embodiment examples. However, the disclosure is not limited to this. Instead, another number of partial surfaces may be provided, in particular more than four partial surfaces. Or, four partial surfaces may be provided which are located in a different manner under the buttocks and/or lower leg region of the person sitting on the seat in the seated position. The mobility of the partial surfaces may be provided as overall movements, as group movements and/or as individual movements.

The present disclosure includes several aspects, each of which individually contributes to solving the aforementioned problem. The disclosed seating technology may comprise one or more of these aspects in any combination.

According to a first aspect of the present disclosure, a seat unit for assisting a seated person is proposed. A seat surface is provided on the seat unit, the seat surface being movable in a driven manner as a whole and/or comprising several movable partial surfaces, wherein a movement pattern of the seat surface and/or these partial surfaces is predetermined and such that the back movement of a riding animal is simulated in at least one gait. The movement pattern can be an overall movement of all partial surfaces and/or a relative movement of individual partial surfaces and/or a relative movement of groups of partial surfaces.

The movement pattern can be specified in any way. Particularly preferably, at least one movement path is predetermined for the seat surface and/or for at least one partial surface, in particular one movement path for each partial surface or at least one movement path for a group of partial surfaces or one movement path for the entirety of the partial surfaces.

According to a further aspect of the disclosure, the seat unit comprises a kinematic unit for presetting the partial surface movements. Preferably, the kinematic unit is a component of the seat unit. In particular, the kinematic unit may be integrated into a housing or support frame of the seat unit. The seat unit may enclose the kinematic unit within itself, wherein only an externally accessible drive flange being provided for supplying kinetic energy. Alternatively or additionally, the kinematic unit may comprise an integrated motor. Accordingly, the (self-contained) seat unit may have a connection for the supply of energy, in particular electric current.

Particularly preferably, the kinematic unit is arranged on the seat surface or below the partial surfaces, in particular directly below the seat surface or the partial surfaces. The provision of a kinematic unit as a component of the seat unit leads to an advantageous compact design, so that the seat unit can be easily adapted for various applications.

According to a further aspect of the disclosure, an inherent movement and/or, on the one hand, a single movement of a partial surface and, on the other hand, a relative movement of the partial surfaces with respect to each other is predetermined for the seat surface. This can be achieved, for example, by a set of movement paths.

The relative movement preferably provides for a lifting and lowering movement in opposite directions of partial surfaces which are arranged on the one hand under the left half of the body and on the other hand under the right half of the body. The relative movement alternatively or additionally provides for a lifting and lowering movement in opposite directions of partial surfaces which are arranged on the one hand under the front seat region (in particular thigh region) and on the other hand under the rear seat region (in particular buttock region). Again alternatively or additionally, the relative movement may provide for a momentary rotation oriented in the same direction for partial surfaces arranged on the one hand under the front seat region and on the other hand under the rear seat region. Such relative movements may be simultaneous or consecutive. They may result from the overall movement of the seat surface and/or be generated separately.

According to a further aspect of the present disclosure, a seat surface having several movable partial surfaces is provided, wherein an actually resulting movement of the partial surfaces is influenced, on the one hand, by which movement possibility is provided for the respective partial surface and/or the entirety of the partial surfaces and/or which relative movement possibility is provided for a group of partial surfaces. On the other hand, the actual resulting movement depends on the movement triggering and/or a movement blocking. The seat unit may comprise separate device components which, on the one hand, influence the movement possibility and, on the other hand, influence the movement triggering.

In the following, the terms “movement possibility” and “movement triggering” are distinguished from each other. The movement possibility indicates in which given limits or paths a movement can take place—independent of whether or how fast it takes place. The movement trigger indicates the reason for which the movement occurs or is permitted. Movement triggers can be a derived drive (e.g. from the pushing movement of a vehicle), a controlled drive (e.g. from a motor) or the weight and/or movement of the seated person.

Preferably, the kinematic unit is provided and designed to predetermine the movement possibility for the seat surface or for at least one partial surface and/or the relative movement possibility for a group of partial surfaces, in particular the movement possibility and/or the relative movement possibility for all partial surfaces, and this independently of the movement triggering. For this purpose, the kinematic unit may comprise a constraint kinematic. The constraint kinematic enforces the adherence of a specific shape of movement and possibly a range of movement, or only allow movement corresponding to the specific shape and possibly the specific range of movement. Movements of the seat surface and/or the partial surface which would deviate from the specific shape or exceed the specific circumference are prevented by the constraint kinematic. The constraint kinematic is preferably designed in such a way that the forced or permitted movement authentically simulates the back movement of a riding animal in a certain gait, in particular the back movement of a horse at a walk or trot.

Preferably, therefore, the possibility of movement of the seat surface (4), at least one partial surface and/or at least one relative possibility of movement of two or more partial surfaces is predetermined or limited by a constraint kinematic.

A further aspect of the present disclosure relates to providing different triggering modes for the movement of the seat surface and/or one or more partial surfaces. These triggering modes may be provided by switchable or controllable kinematics, in particular by a switchable or controllable kinematic unit.

Preferably, the movement can be triggered either exclusively by the weight or body movement of the person sitting on the seat (passive mode) or exclusively by a technical drive (active forced mode) or by a combination (active support mode). Preferably, the switchable kinematics supports at least two of the aforementioned release modes. In addition, a movement lock may be supported in which the seat surface and/or one or more partial surfaces and in particular all partial surfaces are locked. The locking preferably takes place in a predetermined reference position.

The constraint kinematics can specify the form and extent of the possible movement of the seat surface or the respective partial surfaces. On the one hand, this can concern the form of movement and the scope of movement, i.e. in which directions and how far the seat surface or a partial surface can move. On the other hand, a relative position and/or a cycle reference of the possible movements of two or more partial surfaces can be predetermined.

According to another aspect of the present disclosure, the seat unit comprises a constrained kinematic system formed by a gear. The gear may be of any configuration. It may be structured into a plurality of gear units. Preferably, the gear is connected to at least one seat body and/or to at least one partial surface, preferably to a plurality of partial surfaces and in particular to all partial surfaces.

According to a further aspect, the seat unit comprises a technical drive for providing kinetic energy for one or more partial surfaces, i.e. for movement triggering. The technical drive may be fully integrated into the seat unit, in particular housed in or attached to a housing or support frame. Alternatively, the technical drive may have at least a partial energy supply from the outside. The energy supply may preferably be mechanical and/or electrical.

According to a further aspect of the present disclosure, the seat unit comprises a central drive that provides its kinetic energy for the overall movement of the seat surface or for the movements of all partial surfaces. Alternatively or additionally, the seat unit may comprise at least one group drive providing its kinetic energy for one of several seat bodies/a group of partial surfaces. Again alternatively or additionally, the seat unit may comprise at least one individual drive that provides its kinetic energy for exactly one partial surface. Two or more drives can act in parallel for each seat body/partial surface, for example in order to trigger certain parts of the movement. Thus, on the one hand a lifting drive and on the other hand a pushing or swivelling drive can be provided.

One or more gear units can be assigned to each individual drive, group drive or central drive.

All partial surfaces can be arranged on a common seat body, wherein this seat body is moved as a whole by the kinematic unit. The partial surfaces can be rigidly or flexibly connected to the seat body. Thus, the subject matter of the disclosure also includes an inherent movement of the partial surfaces in addition to or overlapping to the movement of the seat body.

Further preferred embodiments are indicated in the drawings, the following description and to the subclaims.

The invention is illustrated by way of example and diagram in the drawings. It shows:

FIG. 1: a schematic oblique view of a seat unit according to the present disclosure;

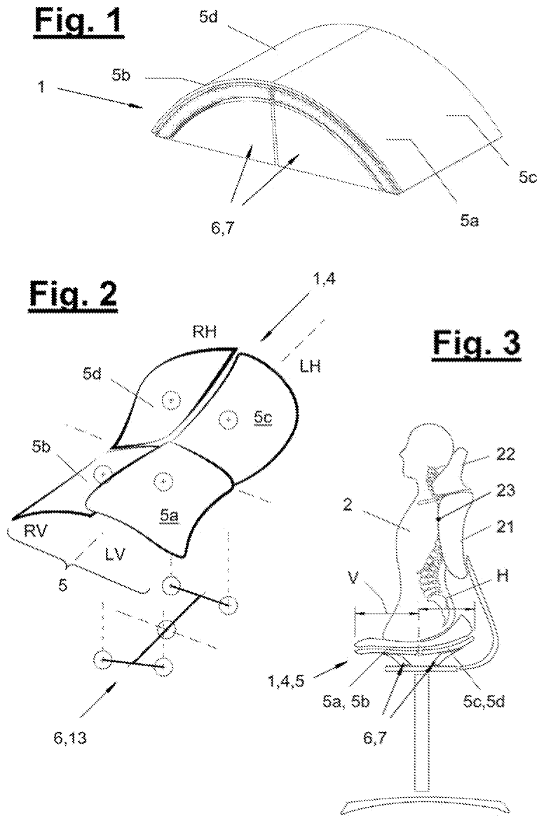

FIG. 2: a schematic representation of a seat surface with four partial surfaces and an example of a kinematic unit;

FIG. 3: a schematic side view of a seat device with a seat unit;

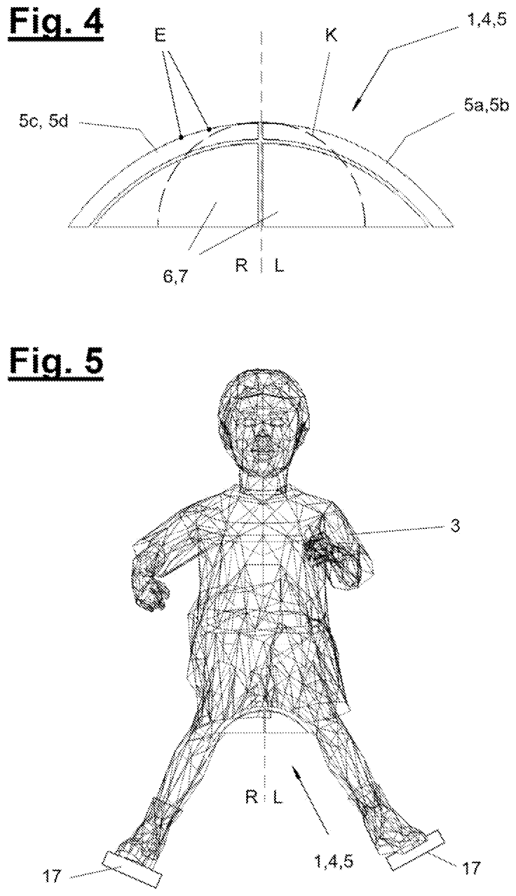

FIGS. 4 and 5: a front view of a seat unit in enlarged view and in an illustration with a child sitting on it;

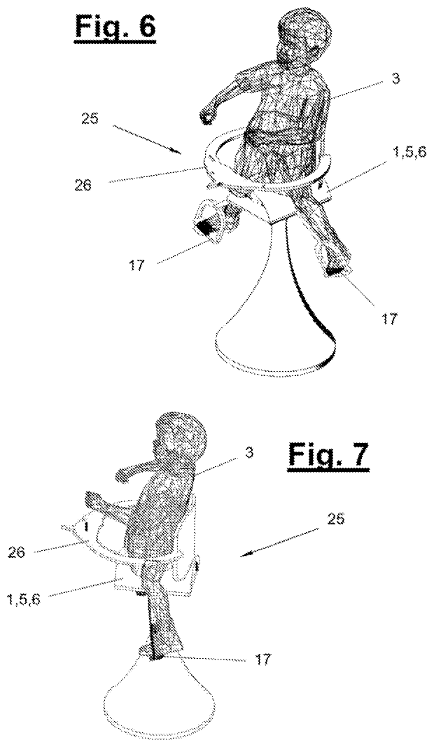

FIGS. 6 and 7: exemplary representations of a seat device in the form of a highchair;

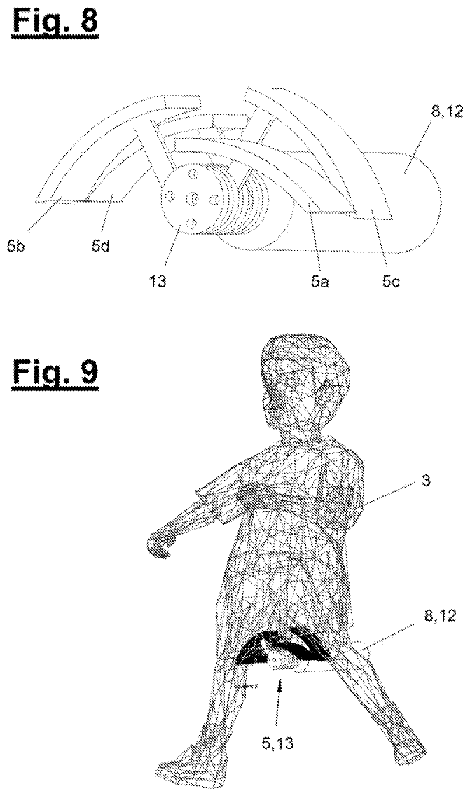

FIGS. 8 and 9: an enlarged individual representation of a kinematic unit with a technical drive in a first embodiment variant as well as a schematic illustration of the drive with a child sitting on it;

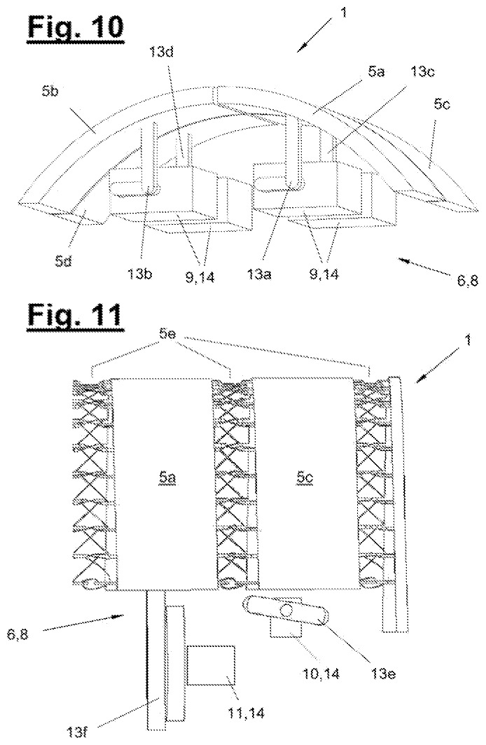

FIG. 10: a further embodiment of a kinematic unit;

FIGS. 11 and 12: a further embodiment of a kinematic unit;

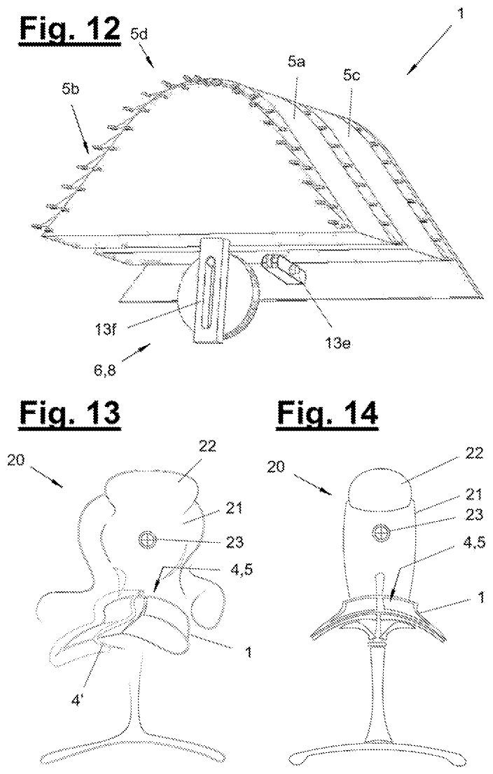

FIGS. 13 and 14: embodiments of a seat device according to the present disclosure in the form of a chair and an office chair;

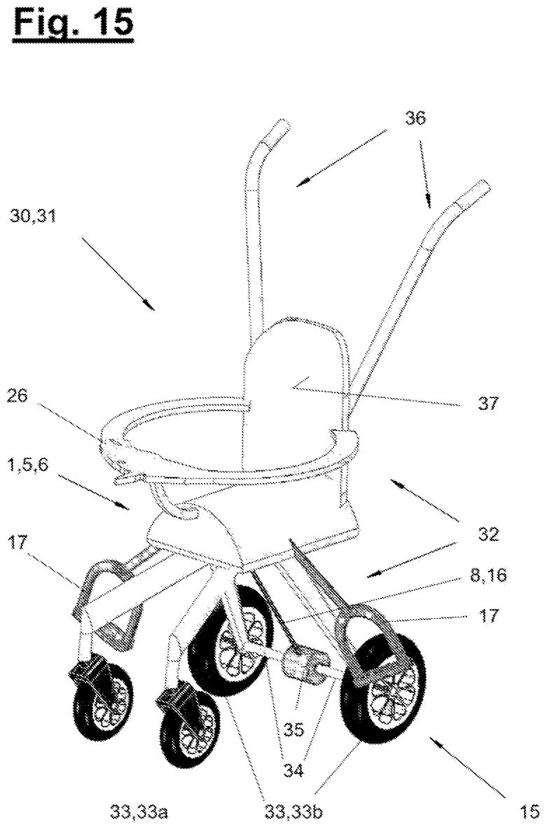

FIG. 15: a first embodiment of a vehicle with a seat unit according to the disclosure

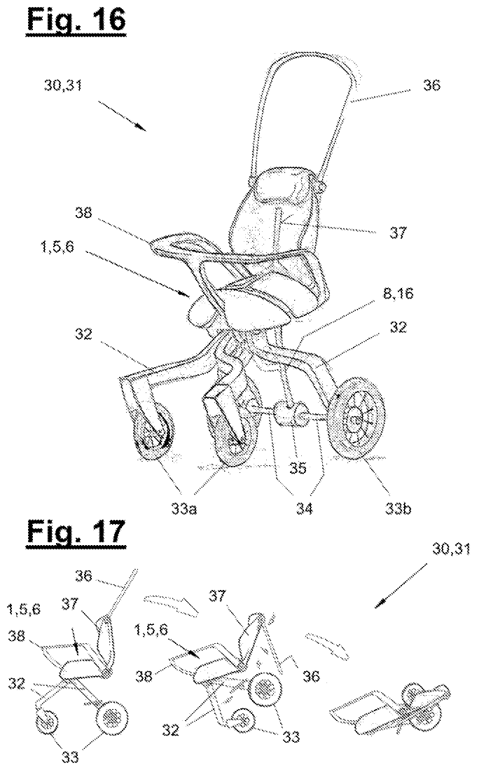

FIG. 16: a second embodiment of a vehicle with a seat unit;

FIG. 17: an example of a foldable frame of the vehicle of FIG. 16;

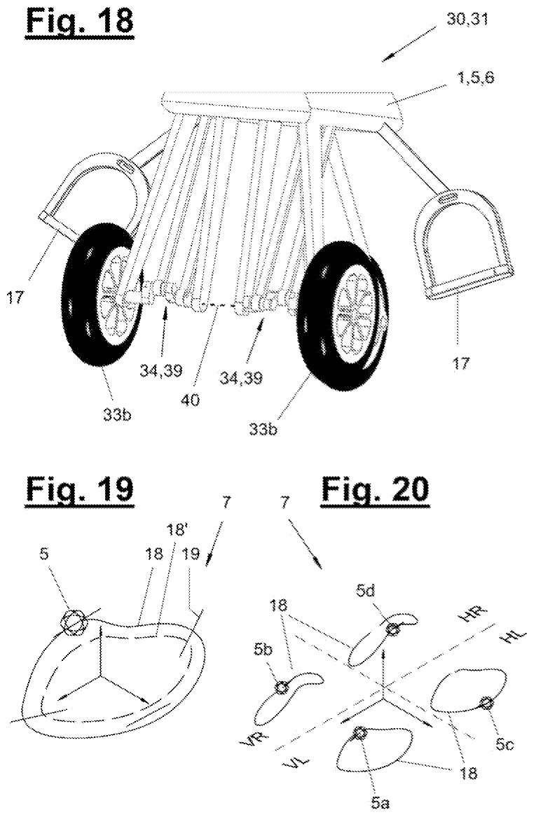

FIG. 18: an example illustration of an alternative embodiment to FIGS. 15 and 16;

FIGS. 19 and 20: examples of a single motion path and of a set of motion paths for predetermining a pattern of motion of partial surfaces.

FIG. 1 shows a schematic representation of a seat unit according to the present disclosure. The seat unit (1) comprises a seat surface (4) on which a person (2, 3) can sit. The seat surface (4) comprises several preferably separately movable partial surfaces (5), in particular a front left partial surface (5a), a front right partial surface (5b), a rear left partial surface (5c) and a rear right partial surface (5d) . The partial surfaces (5) together form the seating surface (4). It is not absolutely necessary that the partial surfaces are physically separated. They may be surface portions of a continuous or one-piece seat surface. In the following examples, for a better illustration of the possibilities of movement, it is assumed that there are at least two seat bodies or four separately movable partial surfaces. However, these seat bodies or separately movable partial surfaces may be provided with a continuous cover or cover surface material (4′), so that they are not necessarily recognizable from the outside. The cover or the cover surface material (4′) can in particular cover joints or transitional areas between the partial surfaces (5) and possibly slightly level them out.

Alternatively to the examples shown, the partial surfaces (5, 5a, 5b, 5c, 5d) may be arranged in groups or as a whole on a seat body. The arrangement of two or more partial surfaces (5, 5a, 5b, 5c, 5d) on a seat body may be rigid or provided with a limited mobility. The seat unit (1) comprises a kinematics unit (6) for predetermining a movement pattern for the partial surfaces (5) and/or the seat body. The kinematic unit (6) can be of any design. It is preferably arranged below, in particular directly below, the seat surface (4) or the partial surfaces (5) or below the seat body.

As explained above, the kinematic unit preferably creates constraint kinematic (7). Furthermore, the kinematic unit is preferably accommodated in a closed housing, so that access from the outside to the moving mechanical components is made difficult or impossible.

FIG. 2 shows an exemplary embodiment of the seat surface (4) of the seat unit (1) in a state in which the partial surfaces (5a, 5b, 5c, 5d) are offset relative to one another in accordance with an instantaneous state of the movement pattern, in particular offset in opposite directions. In the case of partial surfaces which are rigidly arranged on a seat body, the relative positions of the partial surfaces explained with respect to FIG. 2 can be predetermined in two consecutive movement states of the seat surface.

The partial surfaces (5) can have a reference position in which, in particular, the partial surfaces have a substantially uniform height level with respect to one another and/or substantially uniform distances and aligned center positions with respect to one another. Such a reference position is hereinafter referred to as a zero position.

In the reference position, the seat surface and/or the partial surfaces may be unmovablee.

As an alternative to the zero position, another reference position can be provided.

In the example of FIG. 2, the partial surfaces (5) are deflected relative to the zero position according to a movement pattern. The example of FIG. 2 shows individual movements of separately movable partial surfaces, which can be transferred analogously into consecutive movement states of partial surfaces on one or more seat bodies. In the example shown, on the one hand the front left partial surface (5a) and the rear right partial surface (5d) are raised in relation to the reference position. On the other hand, the front right partial surface (5b) and the rear left partial surface (5c) are in a lower position and, for example, lowered relative to the reference position.

FIGS. 19 and 20 show examples of possible movement paths (18) by means of which the movement of the seat surface and/or one or more partial surfaces (5/5a, 5b, 5c, 5d) can be described. In the example shown, the movement paths (18) define the form of a path along which a reference point or suspension point of the seat surface (4) or of a partial surface (5) is moved. Preferably, the path may be predetermined to be unidirectional, that is, the reference point may traverse the movement path (18) only in a predetermined direction and in a substantially annular manner. Alternatively, a bidirectional movement may be permitted.

A movement path (18) may additionally define an instantaneous inclination (19) for one or more positions. The inclination (19) may be defined along one or more axes. According to the definition of the inclination (19), a single-axis or multi-axis tilting movement of a partial surface (5) may be determined.

A movement path (18) may preferably define a basic shape for the intended movement of the seat surface (4) or a partial surface (5). The extent of the movement may preferably be adjustable. In particular, a movement path (18) may give rise to a scaled movement path (18′) which provides a substantially uniform path of movement but a relatively smaller or increased range of movement.

The one or more movement paths (18) are preferably selected such that the movement pattern of the seat surface (4) and/or the partial surfaces (5a, 5b, 5c, 5d) simulates the movement pattern of back surface portions of a riding animal. In other words, the movement pattern is preferably selected and/or the one or more movement paths (18) are formed in such a way that an alternating rolling hip movement is produced for the person sitting on the seat, which is known in equestrian language as a rolling figure eight.

The constraint kinematic (7) or the movement pattern for the partial surfaces (5) thus preferably specifies a relative position and/or a cycle reference of the possible movements for the seat surface or a group of partial surfaces, in particular for all partial surfaces (5). The range of movement of the seat surface or of a partial surface or of a group of partial surfaces can be adjustable, in particular by presetting at least one scaled movement path (18′) or by presetting a scaled movement pattern. The scaling can be used, for example, to adjust the lifting height and/or the running width in the longitudinal direction (front-rear) and/or running width in the transverse direction (left-right).

The kinematic unit (6) may have any physical configuration to generate said motion pattern. Within the scope of the present disclosure, various embodiments are outlined, between which sub-combinations are also possible.

According to the example in FIG. 2, a multi-part gear (13) is sketched. The gear can in particular be designed as a cross gear.

The gear (13) preferably provides, on the one hand, a lifting and lowering movement in opposite directions of partial surfaces (5a, 5b, 5c, 5d) which are arranged, on the one hand, under the front seat region (V), in particular under the thigh region, and, on the other hand, under the rear seat region (H), in particular under the buttocks region. Furthermore, a lifting and lowering movement in opposite directions of partial surfaces (5a, 5b, 5c, 5d) is preferably provided, which are arranged on the one hand under the left half of the body (L) and on the other hand under the right half of the body (R).

In combination, the lifting of the partial surfaces (5a, left front and 5d, left rear) is thus preferably carried out crosswise, paired with a lowering of the partial surfaces (5b, right front and 5c, left rear).

Various seat devices equipped with a seat unity according to the present disclosure are explained below. All of the features explained with respect to these examples may be combined or interchanged with each other in any manner.

FIG. 3 shows a side view of a seat device (20), which is exemplarily designed as an office chair and comprises a seat unit (1) according to the present disclosure. A person (2), exemplarily shown here by the torso and head of an adult, is positioned on the seat surface (4) in such a way that the two rear partial surfaces (5c, 5d) are arranged under the left buttock half on the one hand and the right buttock half on the other hand. The thighs of the person (2) may either be oriented forward and substantially closed, wherein resting substantially fully on top of the left front partial surface (5a) and the right front partial surface (5b). Alternatively, the legs may be in an open and slightly downward position according to the way a rider sits, resting against the left flank of the front left partial surface (5a) as well as the right side flank of the front right partial surface (5b). Furthermore, any intermediate position is possible.

In other words, the seat surface is thus preferably designed to support at least one or preferably two sitting positions. On the one hand, this is a rider sitting pose in which the legs of the person sitting on (2, 3) are open and the thighs rest against the side flanks of the partial surfaces, in particular the front partial surfaces (5a, 5b), extending obliquely downwards. On the other hand, it is a chair sitting pose in which the legs or thighs of the person sitting on (2, 3) are substantially closed and the thighs rest substantially horizontally extending on the front flanks of the partial surfaces, in particular the front partial surfaces (5a, 5b).

In the middle area of the seat surface along the longitudinal direction (front-rear), the apex of an elliptically curved seat contour is preferably arranged. In other words, the seat surface (4) has in cross-section along a transverse axis (left-right), an elliptical contour. This applies in particular to a cross-section which passes through the intended position of the hip joints of the person sitting on the seat.

The elliptical contour is illustrated by way of example in FIG. 4 in a front view of the seat unit (1). The elliptical contour (E) is widened in the transverse direction (left-right) compared to an imaginary circular contour (K). This corresponds to a cross-sectional shape known, for example, from horse saddles.

FIG. 5 illustrates a corresponding arrangement and design of the seat unit (1) under a sitting child (3).

The seat unit (1) or a seat device (20) or a vehicle (30) according to the present disclosure may comprise one or more foot supports (17). Preferably, the foot supports (17) are designed and arranged in such a way that they allow, at least in the aforementioned rider pose, the partial support of the body weight of the person (2, 3) sitting on the seat. One or more additional foot supports (not shown) may be provided for assuming the chair sitting pose. In the accompanying drawings, according to a preferred embodiment, the foot supports (17) are in the form of stirrups.

The seat unit (1) preferably comprises a technical drive (8) for providing kinetic energy, in particular for the movement triggering. The technical drive (8) can be of any design and can be present once or several times. In the following, different embodiments for a technical drive (8) will be explained. Furthermore, various embodiments for a gear (13) or gear units (13a, 13b, 13c, 13d) will be explained. The present disclosure is not limited to these embodiments. Rather, any intermediate combinations of the aforementioned variants may be used and/or other motion-defining technical means adapted to generate the desired motion pattern.

FIGS. 8 and 9 show a first embodiment for a kinematic unit (6) which is formed via a common gear (13) for driving a plurality of and in particular all of the partial surfaces (5a, 5b, 5c, 5d). The gear (13) is formed here in the form of a multiple eccentric. Alternatively, three-dimensionally profiled contour bodies or contour discs may be provided, for example. In addition to the gear (13), further bearing elements (not shown) can be provided, by which the overall movement of the seat surface or of a partial surface is co-determined. Such bearing elements can in particular be, on the one hand, pivot bearings or sliding bearings and, on the other hand, elastic connections or elastic suspensions.

In the example of FIGS. 8 and 9, the gear (13) is connected to a central drive (12). The central drive (12) is preferably designed as an electric actuator (14), in particular as an electric motor. Alternatively or additionally, a mechanical drive (15) may be provided, which will be explained at a later point using the example of a stroller.

In the example shown in FIGS. 8 and 9, the counter-rotating movements explained above are provided by an appropriately selected relative position of the individual eccentrics of the gear (13). Instead of the straight connecting rods shown in FIG. 8, which each connect a partial surface (5a, 5b, 5c, 5d) to an eccentric of the gear (13), any other connecting elements may be provided. Such connecting elements may in particular be gear stages providing for a curved or path-like movement. This can be achieved, for example, by a toggle gear (not shown) and/or a slotted guide (not shown). The partial surfaces may be arranged in groups or as a whole on one or more seat bodies, and may in particular be rigid surface portions of the seat body or bodies, or surface portions of the seat body or bodies which are elastically movable with respect to one another.

In the example of FIG. 10, a separate individual drive (9) is provided for each partial surface (5a, 5b, 5c, 5d) to provide kinetic energy. Each of the individual drives (9) is connected to the respective partial surface (5a, 5b, 5c, 5d) via a separate gear unit (13a, 13b, 13c, 13d). Such an embodiment has the advantage that the movement pattern or the movement path can be specified separately for each partial surface (5a, 5b, 5c, 5d) at least with respect to the circumference. Furthermore, a cycle reference for a relative movement between two or more partial surfaces (5a, 5b, 5c, 5d) can possibly be varied and adapted in a desired manner by a corresponding control of the individual drives (9). Analogous to the above embodiments, in the example of FIG. 10 a separate eccentric is shown as a gear unit (13a, 13b, 13c, 13d) for each individual drive (9). This is only a schematic representation. Alternatively, any other gear forms are possible and, in particular, gear forms which specify a curved or path-shaped movement path (18).

In the examples of FIGS. 11 and 12, a further embodiment variant is again sketched. Here, the partial surfaces (5a, 5b, 5c, 5d) are coupled to each other and possibly to a housing or support frame of the seat unit (1) by means of an elastic connection (5e). The elastic connection (5e) is formed here by a lacing, in particular a cross lacing. (In each case) two or more partial surfaces (5a+5b/5c+5d) are thereby arranged together on a seat body, which is moved as a whole by the kinematic unit. In the example of FIG. 5, a first seat body is formed with the front partial surfaces (5a, 5b) and a second seat body is formed with the rear partial surfaces (5c, 5d). In an alternative embodiment, the distribution of the partial surfaces over the one or more seat bodies may be chosen differently. In particular, exactly one seat body can be provided on which all partial surfaces (5) are arranged.

Two gear units (13e, 13f) are shown below the seat surface (4) or below the partial surfaces or the at least one seat body. In the example of FIG. 11, each of the two gear units (13e, 13f) drives in each case a group of partial surfaces (5a, 5b, 5c, 5d) or predetermines their movement possibility. The first gear unit (13e) is a lifting eccentric which effects lifting or lowering substantially in a vertical direction. The second gear unit (13f) is formed by a transverse thrust eccentric, which in the example effects an offset movement running in the lateral direction (left-right). Both gear units act as a result of the elastic connection (5e) to both seat bodies and thus indirectly to all partial surfaces. If only one seat body is provided on which all partial surfaces are arranged, both the first gear unit (13e) and the second gear unit (13f) can act together on the one seat body to predetermine the movement of all partial surfaces.

The gear units (13e, 13f) shown may each be present single or multiple. Furthermore, one or more group drives (10, 11) may be provided which, in particular, each supply a gear unit (13e, 13f) and thus a group of partial surfaces (5a, 5b, 5c, 5d) with kinetic energy.

In other words, the technical drive (8) may thus comprise at least one group drive (10, 11) which provides its kinetic energy for a group of partial surfaces or a seat body with several partial surfaces. Alternatively or additionally, the technical drive (8) may comprise at least one individual drive (9) which provides its kinetic energy for exactly one partial surface. Again alternatively or additionally, the technical drive (8) may comprise at least one central drive (12) which provides its kinetic energy for all partial surfaces (5) or the seat surface (4) as a whole. In the examples shown in FIGS. 8 to 12, these drives (9, 10, 11, 12) are designed as electric actuators, in particular as controllable electric motors. Particularly preferred variants are a torque motor, in particular a brushless DC motor, as well as a actuator motor (also called servo motor). It is also possible to use a conventional direct current or alternating current motor, possibly with a gear connected in series to adjust the speed.

A particularly preferred embodiment provides for a control of the electric actuator or a control for the electric motor, so that its rotational speed, torque or rotational position can be adjusted to an instantaneous set value.

By controlling or regulating a rotational speed, a substantially fixed or forced predetermined dynamic may be defined for the motion pattern. This type of regulation or control is favorable for the forced active motion mode. By controlling or regulating a torque or a force of the technical drive, it is achieved that forces of the same or opposite direction on one of the partial surfaces (5) also influence their movement. This type of control or regulation is suitable for the assisted driving mode of movement.

The cycle reference can be changed by controlling or regulating the position or location of a technical drive (8). Alternatively or additionally, at least one partial surface (5a, 5b, 5c, 5d) can be moved into a target position and held there. The target position can in particular be the reference position of the partial surface. A controlling or regulating of the position may be correspondingly suitable for achieving a movement lock.

Finally, it is possible to switch at least one technical drive (8), in particular at least one electric actuator (14) force-free, so that it freely permits a movement imposed from the outside. Alternatively or additionally, a technical drive (8), in particular an electric actuator (14) can be controlled or regulated in such a way that it can move freely in one direction of movement, but locks in the opposite direction of movement. This type of control or regulation can support a passive movement mode of the seat unit (1).

As can be seen from the embodiment in the aforementioned figures, the technical drive (8) can preferably be integrated into the kinematic unit (6).

The seat unit (1), and in particular the kinematic unit (6), may comprise a switching device by which to switch between at least two kinematic modes. The kinematic modes may in particular correspond to the aforementioned movement mode and comprise:
Movement triggering exclusively by the technical drive (forced active movement mode, for example speed control);
Movement triggered solely by the weight and/or body movement of a seated person (passive movement mode, for example position or attitude control);
Movement triggering combined by the technical drive and the weight and/or body movement of a person sitting on it (supporting active movement mode, for example force or torque control);
Movement blocking with locking of the seat surface and/or at least one partial surface (blocked movement mode, for example position control to a reference position).

The reference position can in particular be a zero position in which the partial surfaces are arranged relative to one another without any height offset.

The dynamics for the movement of the seat surface and/or the partial surfaces can be selected as desired. According to a preferred embodiment, a seat surface or partial surface movement is to be provided with a lifting period of 1.5 to 2.5 Hz. Accordingly, preferably about 110 to 120 strokes per minute are to be provided. The seat unit (1) and/or the kinematic unit (6) and/or the control of the technical drive (8) may be provided and designed accordingly. Alternatively, any other faster or slower seat surface or partial surface movement is possible.

The circumference of the partial surface movement can also be selected as desired. According to a preferred variant, the lifting height of a partial surface (5a, 5b, 5c, 5d) is provided in a range from about 25 to 35 mm. In particular, an average lifting height may be 30 mm. From the aforementioned definitions for a lifting height, an equivalent limitation of the tilting or pivoting movement for a seat surface moved as a whole is obtained.

The technical drive (8) can provide any proportion of the kinetic energy necessary to raise the seat surface or at least one partial surface (5a, 5b, 5c, 5d) against the weight force acting on it. However, it is preferred that the seat surface and/or a partial surface (5a, 5b, 5c, 5d) is mounted in such a way that an elastic supporting force acts in the vertical direction parallel to the driving force of the technical drive. The supporting force can thereby partially or completely compensate for the weight force which is applied to the seat surface or the respective partial surface by the body weight of the person sitting on it.

The supporting force may be applied by any technical means, in particular by a tension spring, a compression spring, a torsion spring or any other elastic body.

By providing a parallel acting elastic supporting force, the energy consumption for one of the aforementioned active movement modes can be significantly reduced. When using an electric actuator (14), an energy consumption or current consumption can be reduced accordingly. If a mechanical drive (15) is used (see following embodiments), a correspondingly smaller amount of kinetic energy to be supplied from the outside is required.

In a variation on the above examples, the technical drive (8) may comprise several separate drive units, several group drives (10, 11), in order to trigger, on the one hand, a lifting movement and, on the other hand, a lateral offset movement for at least one partial surface and, in particular, for several identical or different groups of partial surfaces (5a, 5b, 5c, 5d).

The gear (13) can comprise at least one lifting eccentric (13e) which converts a rotary movement of the technical drive (8) at least proportionally into a lifting movement of at least one partial surface and, in particular, of at least one group of partial surfaces (5a, 5b, 5c, 5d).

Alternatively or additionally, the gear (13) can comprise at least one transverse thrust eccentric (13f) which converts a rotary movement of the technical drive (8) at least proportionally into a lateral offset movement of at least one partial surface, in particular at least one group of partial surfaces (5a, 5b, 5c, 5d).

In a further variation to the aforementioned examples, the kinematic unit (6) or the technical drive (8) may comprise a fluid cylinder for directly triggering a lifting movement of at least one partial surface (5a, 5b, 5c, 5d). By means of such a fluid cylinder, the function of a gear (13) can thus be combined or integrated with the function of a technical drive (8).

Accordingly, the kinematic unit (6) or the technical drive (8) may comprise a fluid cylinder for directly triggering a lateral offset movement of the seat surface or of at least one partial surface (5a, 5b, 5c, 5d). The at least one fluid cylinder may be supplied, for example, by a source of compressed air and/or by a source of hydraulic pressure. Control or regulation may be provided by one or more valve controllers and/or throttle controllers, analogous to the above modes. Accordingly, a speed control, a force control, a position control, or a motion lock can be implemented.

In each of the explained embodiments for the kinematic unit (6), a mechanical drive unit (15) may be provided as an alternative or in addition to an electric actuator (16), which provides its kinetic energy for the movement of at least one partial surface (5a, 5b, 5c, 5d). Accordingly, the central drive (12), an individual drive (9) and/or a group drive (10, 11) may be formed by a mechanical drive mechanism (15). The mechanical drive unit (15) preferably has a drive shaft (16) which can be moved from the outside, i.e. the mechanical drive unit (15) preferably provides the kinetic energy via a rotating drive. Alternatively or additionally, the kinetic energy may be provided by a connecting rod drive (39), i.e. an alternating translatory motion. These embodiments will be discussed further below.

The aforementioned seat unit (1) may be provided in any seat device (20) or any vehicle (30) once or more than once. According to the example of FIGS. 6 and 7, a seating device may be, for example, a high chair, in particular a child's high chair (25), and may comprise a seat unit (1) according to the present disclosure. According to the example of FIGS. 3, 13 and 14, the seat device may also be formed as an armchair or an office chair (20). It is advantageous if the seat unit (1) or the seat surface (4) comprises the following components in a layered structure from the outside to the inside:
1. a flexible cover which forms a closed overall surface over the seat surface (4) or over the partial surfaces;
2. below this, the several preferably separately movable partial surfaces which act as active seat surface partitions; and
3. below this, the kinematic unit, which preferably comprises a gearbox and possibly a technical drive for presetting the forced kinematics.

The flexible cover may be adapted to the particular field of use. In a chair or armchair according to FIG. 13, the cover may be formed by a cover (4′) having a substantially soft texture conducive to the comfort of the person sitting on it. In an office chair according to FIGS. 3 and 14, the flexible cover may be formed by a firmer material and have, for example, an anti-slip finish. It may further have a firmer texture and/or be made liquid repellent or liquid tight.

According to a preferred variant, the seat surface of the seat unit (1) is combined with a special backrest shape of the backrest (21). The backrest (21) is thereby preferably designed as a shoulder-high backrest or as a full backrest. It further preferably has in the upper third, i.e. in the region which comes to lie behind the thoracic vertebrae, a curvature (23) directed towards the person (2, 3) sitting on it. This supports an upright sitting position. The upright sitting position is further advantageous because then the hip movements triggered or supported by the seat unit (1) can be easily executed and/or a physiologically beneficial body movement pattern is promoted.

A headrest (22) is preferably further provided on the backrest (21). The headrest is preferably arranged adjacent to the section of the backrest (21) which forms the bulge (23). Particularly preferably, the headrest is arranged and oriented to act in a region of transition from the thoracic spine to the cervical spine. In other words, the headrest supports this transition area from the thoracic spine to the cervical spine so that a major part of the weight force of the head can be supported.

The backrest (21) with the curvature (23) and/or the headrest (22) may particularly preferably be provided according to the disclosure in WO 2018/210910 Al.

The seat surface (5) can furthermore preferably have a rising contour in the rear area, in particular where the coccyx and the higher buttock areas rest. This rising contour also promotes an upright posture and supports free mobility in the hip area.

FIGS. 6 and 7 show a preferred embodiment of a high chair according to the present disclosure, which may in particular be a children's high chair (25). The high chair (25) comprises a bracket (26) arranged above the seat surface (5) of the contained seating unit (1). The arrangement of the bracket (26) is in particular chosen to form a fall-out protection and/or a table surface for a sitting child (3). A backrest, in particular a partial backrest, is preferably provided at the rear end of the seat surface (5). The seat surface (4) is designed as a saddle seat. The backrest and the bracket may be individually or jointly height-adjustable relative to the seat surface (5). Furthermore, the seat surface (5) with or without bracket and/or backrest can be adjustable in height relative to a base of the high chair.

Preferably, the high chair (25) comprises an actuation means (27, 27′) to select or switch the kinematic mode or movement mode of the seat unit (1). A first embodiment provides that the actuating means (27) is arranged on the rear side of the high chair (25), so that the actuating means (27) can only be operated by an outside person, but not by the sitting child (3). Preferably, this actuating means (27) may allow (full) access to all existing kinematic modes or movement modes. Alternatively or additionally, an actuating means (27′) may be arranged in an area that is easily accessible for the sitting-on child (3), in particular on or at the bracket (26). The actuation means (27′) may possibly provide limited access to the available kinematic modes or movement modes.

The high chair (25) preferably comprises at least one movable footrest (17) for the child (3) sitting on it. The footrest (17) is in particular arranged to be freely suspended and/or designed as a stirrup. It can be provided in particular for assuming the rider sitting pose.

Alternatively or additionally, one or more foot supports may be provided, in particular fixed foot supports or foot supports that can be fixed in specific positions. These further footrests can be provided in particular for placing the feet in the chair sitting pose.

The seat unit according to the present disclosure may be one or more components of a vehicle (30). The vehicle may have any design. In particular, it may be configured as a motor vehicle in which, in particular, the seat unit (1) is accommodated in a vehicle seat. Alternatively, the vehicle (30) may be configured as a means of public transport in which, in particular, the seat unit (1) is accommodated in a passenger seat. The means of transport may, for example, be a bus, a rail vehicle, an aircraft or a watercraft.

Again alternatively, the vehicle may be a wheelchair or other vehicle for transporting persons with reduced mobility or health. In particular, the seat unit (1) may be received in a patient support surface.

A particularly preferred embodiment of the vehicle (30) is a child transport vehicle (31). Examples thereof are shown in FIGS. 15 to 18. The child transport vehicle (31) may in particular be a stroller, more specifically a seated stroller. Alternatively or additionally, the child transport vehicle (31) may have a lying function.

The stroller has a frame (32), several wheels (33), and a seat unit (1) according to the present disclosure.

In the following, with reference to FIGS. 15 to 18, a vehicle is described in general terms. The features mentioned are in particular applicable to the child transport vehicle/stroller (31) shown.

The vehicle (30, 31) preferably comprises a mechanical drive (15). It is designed to convert a kinetic energy of the wheels (33) of the vehicle into a movement triggering for the seat surface (4) and/or at least one partial surface (5a, 5b, 5c, 5d) on the seat unit (1). Alternatively or additionally, the vehicle may comprise a technical drive (8) in the form of an electric actuator (14). All the embodiments described above concerning the seat unit (1) or the seat devices, in particular the high chair for children, can be provided in the same way in the vehicle (30, 31).

The wheels (33) of the vehicle (30,31) may have any configuration. Particularly preferably, in particular in a child transport vehicle (31) two running wheels (33b), i.e. non-steerable and non-driven wheels, and at least one steerable wheel (33a) are provided. The mechanical drive (15) may obtain kinetic energy from at least one of the wheels (33), in particular from one or more running wheels (33b). For this purpose, the wheel axles of the running wheels (33) may be coupled to the seat unit via a mechanical drive unit. The mechanical drive (15) can accordingly form a technical drive (8) for the seat unit (1) or supply the seat unit (1) with kinetic energy. In particular, the kinetic energy can be converted into the above-described movement of one or more partial surfaces (5a, 5b, 5c, 5d) via the kinematic unit (6) arranged under the seat surface (5). Particularly preferably, the kinetic energy is provided by (exactly or at least) one running wheel (33b) for the movement triggering of a group of partial surfaces (5a, 5b, 5c, 5d). In other words, the steerable wheels may be without energy conducting connection to the seat unit.

FIGS. 15 and 16 show a particularly preferred drive variant. Here, the mechanical drive (15) comprises a drive shaft (16), which can in particular be designed as a central drive shaft. The drive shaft (16) can thus transmit the kinetic energy of at least one wheel (33), in particular at least one running wheel (33b), which is provided via the wheel axles, to a gear (13) of the seat unit (1) by means of a rotary movement of the drive shaft (16). The transmission of the kinetic energy by means of a rotating drive shaft (16) is advantageous for various reasons. On the one hand, the drive shaft (16) presents a low risk of injury or accident. The drive shaft (16) can be easily housed in a rigid enclosure or provided with a protective cover to limit or eliminate manual access, so that the risk of injury is reduced. The rotating drive shaft (16) also requires minimal installation space.

A particularly advantageous variant provides that two running wheels (33b), in particular two rear running wheels (33b), are connected via a differential (35), from which a combined kinetic energy of these running wheels (33b) is provided for moving the seat surface and/or the partial surfaces (5, 5a, 5b, 5c, 5d), in particular by means of the drive shaft (16). The drive shaft (16) is a driving member of the mechanical drive (15) and is to be distinguished from the wheel axles or wheel hubs of the wheels (33). The differential may be directly or indirectly connected to the wheel axles of the driving wheels (33).

The aforementioned embodiment of a stroller with differential for driving the seat surface or partial surface movement is shown in FIGS. 15 and 16. Due to the differential (35), the running wheels (33b) can be moved at different speeds and possibly even different directions. Preferably, the differential causes the drive shaft (16) to rotate at a speed according to half the sum of the individual rotational speeds of the wheels (33) or the running wheels (33b). Accordingly, the child transport vehicle can be moved on paths of any shape, in particular on straight as well as curved paths, without the transmission of the kinetic energy to the seat unit (1) restricting the mobility.

The term “differential” includes a differential gear (axle differential), i.e. a gear with two drive elements connected to the wheels (33) and an output connected to the seat unit (1) or to the input shaft (16) or to another suitable energy-transmitting technical means. In addition, the term “differential” also includes differential gears or planetary gears or other means corresponding in technical effect.

The frame (32) of the child transport vehicle (31) may preferably be foldable. Any mechanism may be provided for the folding mechanism. Folding preferably brings the frame struts to which the wheels (33) are attached, or at least parts of the frame struts, closer to the seat unit, so that the stroller occupies a reduced volume of space when folded. Alternatively or in addition to the foldable frame, a pivoting backrest may be provided which is preferably hinged to the seat assembly to allow for an even more compact shape when foldable.

A particularly preferred variant provides that the wheels (33) are connected to the seat area of the child transport vehicle (31) via a common swivel joint. This is shown by way of example in FIG. 17. The backrest (37) of the vehicle (30, 31) may be connected to the seat area via a further joint, in particular at the rear end of the seat area. Preferably, the seat unit (1) according to the present disclosure is arranged in the seat area. The drive shaft (16) may optionally be detachably connected to the seat unit (1) or the kinematic unit (6). FIG. 17 shows this detached position.

The vehicle (30, 31) preferably also comprises a push linkage (36) and/or a bracket (38). The bracket can be designed analogously to the embodiments for the child's high chair and, in particular, can form a table or a fall-out protection.

The push linkage (36) and/or the bracket (38) may be detachably or movably arranged. According to the preferred embodiment of FIGS. 16 and 17, the push linkage (36) may be attached to the backrest (37), in particular to the upper end of the backrest (37), via a folding joint.

According to the variant shown in FIG. 17, the seat area and the backrest of a child transport vehicle (31) can be aligned obliquely (with an acute angle to each other) or substantially coplanar to form an outer contour that is as flat as possible in a folded state. Preferably, the push linkage (36) can be laid flat against the coplanar aligned group of seat portion and backrest (37). FIG. 17 shows an application to the rear sides, alternatively the push linkage (36) can be applied to the front or to the upper sides.

The wheels (33) are preferably connected to the common pivot joint via frame struts (or frame arms), wherein the frame struts being movable and mounted in the folded state such that the frame struts of the front wheels (33a) are movable laterally adjacent the frame struts of the rear wheels (33b). Preferably, the entire group of frame struts of front wheels (33a) and rear wheels (33b) can be placed against the rear side of the coplanar aligned group of seat area and backrest (37) in the folded state.

FIG. 18 shows an alternative design variant for a mechanical drive (15). In the variant shown with solid lines, each of the running wheels (33b) (here rear wheels) is separately connected to a connecting rod drive (39). The left connecting rod drive (39) can be provided for initiating a lifting and lowering movement of the front as well as the rear left partial surfaces in opposite directions, while the other connecting rod drive (39) sets the remaining partial surfaces in a lifting and lowering movement in opposite directions. Alternatively, the connecting rod drives (39) may be interconnected by an axle connection (40). Again alternatively, a single running wheel (33b) can supply several connecting rod drives (39) or a central connecting rod drive with kinetic energy for all partial surfaces.

Variations of the invention are possible in various ways. In particular, any of the features described with respect to the embodiments, shown or claimed in the figures may be combined or interchanged in any desired manner.

Instead of a connecting rod drive (39) or a rotatable drive shaft (16), any other energy-transmitting technical means can be provided, for example a chain drive, a belt drive or a gear drive. Furthermore, intermediate solutions are possible.

It is further possible to form the seat unit (1) on a child transport vehicle (31) with an electric actuator (14). The electric actuator (14) can be powered by a mobile power supply, in particular by an electric accumulator or a battery. Alternatively or additionally, a generator or dynamo may be provided which temporarily or permanently converts the kinetic energy of at least one wheel into electrical energy to charge the electrical power storage device or directly supply the electrical actuator (14). Alternatively or additionally, the electrical storage may be charged by an external energy source. The external energy source may be, for example, a supply port in a motor vehicle, so that the energy storage may be charged in the car during transport.

In order to provide a uniform resistance, it is preferred that the kinetic energy is provided by exactly one running wheel (33b) for the movement triggering on at least two partial surfaces (5a, 5c/5b, 5d), which are located in particular on the one hand under the front seat area (V) and on the other hand under the rear seat area (H). This can be achieved by any of the aforementioned drive variants and in particular by the connecting rod drive (39) shown in FIG. 18, wherein each of the connecting rod drives (39) being connected to exactly one running wheel (33b).

If the number of movable partial surfaces differs from the preferred number of four, it is advantageous to create an arrangement symmetrical to the longitudinal axis (front-rear).

All components and functions explained with respect to the kinematic unit (6) may also be separate components or functions of the seat unit (1), the seat device (20, 25) or the vehicle (30, 31) and vice versa.

Independently disclosed is a stroller (or seat-stroller) comprising a frame (32), a plurality of wheels (33) and a seat unit (1), wherein the seat unit (1) is designed to support a person (2, 3) sitting on it and comprises a seat surface (4) with several partial surfaces (5/5a, 5b, 5c, 5d) which can be moved individually, in groups or as a whole, and wherein a pattern of movement of the seat surface (4) and/or of the partial surfaces (5) is predetermined in such a way that the back movement of a riding animal is simulated in at least one gait, and wherein the stroller has a mechanical drive (15) which is designed to convert a kinetic energy of the wheels (33) into a movement triggering for the seat surface and/or at least one partial surface (5, 5a, 5b, 5c, 5d) on the seat unit (1).

Particularly preferably, such a stroller comprises a differential, wherein at least two wheels (33) are connected via the differential (35), from which a combined kinetic energy of these wheels (33) is provided for the movement of the seat surface and/or the at least one partial surface. The kinetic energy may be provided by the differential in particular for at least one seat body or a group of partial surfaces or for the entirety of the partial surfaces.

A stroller according to the present disclosure may comprise at least one seat body on which at least two of the partial surfaces are arranged. In particular, as preferred embodiments, the stroller may comprise exactly one seat body on which all of the partial surfaces (5, 5a, 5b, 5c, 5d) are arranged, or two seat bodies on each of which two partial surfaces are arranged.

The seat unit (1) of a stroller preferably comprises a kinematic unit (6) for presetting the partial surface movements, wherein the kinematic unit being arranged in particular (directly) below the partial surfaces (5) or the seat body.

### LIST OF REFERENCE SIGNS

1 seat unit

2 person/adult

3 person/child

4 seat surface

4′ cover/cover material

5 partial surfaces

5a partial surface (VL)

5b partial surface (VR)

5c partial surface (HL)

5d partial surface (HR)

5e elastic connection/lacing

6 kinematic unit/unit for predetermining a movement pattern

7 constraint kinematic

8 technical drive

9 single drive

10 group drive

11 group drive

12 central drive

13 gear

13a gear unit

13b gear unit

13c gear unit

13d gear unit

13e gear unit for lifting component/lifting eccentric 3f gear unit for swivel component/transverse thrust eccentric

14 electric actuator/electric motor

15 mechanical drive

16 drive shaft

17 footrest/stirrup

18 movement path

18′ scaled motion path

19 current slope

20 seating device/office chair

21 backrest/shoulder-high backrest/full backrest

22 headrest

23 bulge

25 seat device/high chair

26 bracket/table (removable)

27 actuating means/kinematic switch

27′ actuating means/kinematic switch

30 vehicle

31 child transport vehicle/stroller

32 frame

33 wheels

33a steerable wheels

33b running wheels (non-steerable)

34 axis

35 differential

36 push rods

37 backrest

38 bracket/table (removable)

39 connecting rod drive

40 axle connection

E elliptical contour

K circular contour

L left half of the body

R right half of the body

V front seat area (on/under thigh)

H rear seat area (under buttocks)

1. A stroller comprising a frame with at least two wheels and a seat unit for supporting a person sitting on it, wherein the seat unit comprises a seat surface and wherein the seat surface is designed so as to be driven movable and/or the seat surface has several driven movable partial surfaces, and wherein a movement pattern of the seat surface and/or of the partial surfaces is predetermined in such a way that the back movement of a riding animal is simulated in at least one gait,
wherein
the seat unit comprises a kinematic unit configured for presetting the movement of the seat surface or the partial surfaces, wherein the kinematic unit being arranged directly below the seat surface or directly below the partial surfaces, AND/OR wherein
the stroller comprises a mechanical drive and a differential, and wherein the differential is connected to at least two wheels in such a way that a combined kinetic energy of these wheels is provided for the movement of the seat surface or the partial surfaces.

2-5. (canceled)

6. The stroller according to claim 1, wherein at least two seat bodies with partial surfaces arranged thereon are provided.

7. The stroller according to claim 1, wherein the two or more partial surfaces are rigidly or flexibly connected to the seat body.

8. The stroller according to claim 1, wherein the back movement of a riding animal is simulated by predetermining at least one movement path for a partial surface.

9. The stroller according to claim 1, wherein on the one hand a single movement of a partial surface and on the other hand a relative movement of several partial surfaces with respect to one another can be predetermined, in particular by a set of movement paths.

10. The stroller according to claim 1, wherein a lifting and lowering movement in opposite directions of partial surfaces is provided, which are arranged: on the one hand under the left half of the body and on the other hand under the right half of the body, or on the one hand under the front seat region, in particular under the thigh region, and on the other hand under the rear seat region, in particular under the buttocks region.

11. (canceled)

12. The stroller according to claim 1, wherein a momentary rotation oriented in the same way is provided for partial surfaces which is arranged on the one hand under the front seat region, in particular under the thigh region, and on the other hand under the rear seat region, in particular under the buttocks region.

13-15. (canceled)

16. The stroller according to claim 1, wherein the seat unit comprises a switchable or controllable kinematic, in particular a switchable or controllable kinematic unit, such that the movement triggering is enabled:
solely by the weight or body movement of the person sitting on it, OR
exclusively by a technical drive, OR
by a combination of technical drive and weight or body movement of the person sitting on the seat.

17. The stroller according to claim 1, wherein the seat unit comprises a gear forming a constrained kinematic.

18. The stroller according to claim 1, wherein the constrained kinematic predetermines:
the possible form of movement, in particular a path-like course of movement, AND
the possible range of movement of the seat surface and/or a partial surface, or
the possible form of movement, in particular several path-like courses of movement, AND
the possible ranges of movement of a seat body or a group of partial surfaces, in particular of all partial surfaces.

19-20. (canceled)

21. The stroller according to claim 1, wherein a constraint kinematic predetermines a relative position and/or a cycle reference of the movements for a group of partial surfaces, in particular for the movements of all partial surfaces.

22. The stroller according to claim 1, wherein the seat unit comprises a technical drive for providing kinetic energy.

23. (canceled)

24. The stroller according to claim 1, wherein the technical drive comprises:
at least one group drive configured to provide its kinetic energy for one of several seat bodies or for a group of partial surfaces, AND/OR
at least one individual drive configured to provide its kinetic energy for exactly one partial surface, AND/OR
a central drive configured to provide its kinetic energy for the entire seat surface or all partial surfaces, AND/OR
separate drive units, in particular group drives configured to trigger, on the one hand, a lifting movement and, on the other hand, a lateral offset movement of the seat surface and/or at least one partial surface.

25. The stroller according to claim 1, wherein one or more gear units are associated with each individual drive, group drive or the central drive.

26. The stroller according to claim 1, wherein the central drive, an individual drive and/or a group drive:
is formed by the mechanical drive unit, in particular by an externally movable drive shaft, OR
is additionally formed by an electric actuator, in particular by a controllable or adjustable electric motor.

27. (canceled)

28. The stroller according to claim 1, wherein the kinematic unit comprises a switching device by which it is switchable between at least two of the following kinematic modes:
movement triggering exclusively by the technical drive;
movement triggered exclusively by the weight and/or body movement of a person sitting on the chair;
movement triggering combined by the technical drive and the weight and/or body movement of a person sitting on it; and
movement lock with locking of the seat surface and/or locking of at least one partial surface, in particular all partial surfaces.

29. The stroller according to claim 1, wherein the kinematic unit is configured to lock two or more of the movable partial surfaces, in particular all partial surfaces, in a zero position in which the partial surfaces are arranged without height offset relative to one another, AND/OR is adapted to provide the movement of the seat surface and/or a partial surface movement with a lifting period of 1.5 to 2.5 Hz, in particular with about 110 to 120 lifts per minute.

30-31. (canceled)

32. The stroller according to claim 1, wherein the seat surface and/or a partial surface is mounted in such a way that the following forces act in parallel in the vertical direction:
an elastic supporting force which partially or completely compensates for a weight force exerted by the body weight of the person sitting on the seat surface or this partial surface, and
a driving force of technical drive.

33. (canceled)

34. The stroller according to claim 1, wherein the gear comprises at least one lifting eccentric configured to convert a rotary movement of the technical drive at least proportionally into a lifting movement of the seat surface or of a seat body or of at least one partial surface, AND/OR
at least one transverse thrust eccentric configured to convert a rotary movement of the technical drive at least proportionally into a lateral offset movement of the seat surface or of a seat body or at least of a partial surface.

35. (canceled)

36. The stroller according to claim 1, wherein the kinematic unit comprises a fluid cylinder configured for directly triggering a lifting movement of at least one partial surface, AND/OR a lateral offset movement of the seat surface or a seat body or at least one partial surface.

37. (canceled)

38. The stroller according to claim 1, wherein the seat surface is adapted to support two sitting positions, namely
a rider seated pose in which the legs of the person seated are open and the thighs are obliquely down against the side flanks of the partial surfaces, and
a chair sitting pose in which the legs of the person sitting on the chair are substantially closed and the thighs rest substantially horizontally on the front flanks of the partial surfaces.

39-44. (canceled)
